(19) United States
(12) Patent Application Publication
(10) Pub. No.: US 2026/0183181 A1
(43) Pub. Date: Jul. 2, 2026

(54) VIBRATING SPEAR

(71) Applicant: KISSKY (HK) LIMITED, HONG KONG (HK)

(72) Inventor: Dewei LUO, HONG KONG (HK)

(73) Assignee: KISSKY (HK) LIMITED, HONG KONG (HK)

(21) Appl. No.: 19/006,092

(22) Filed: Dec. 30, 2024

(51) Int. Cl. A61H 19/00; A61H 23/00; A61H 23/02

(52) U.S. Cl. CPC A61H 19/44; A61H 19/34; A61H 23/006; A61H 23/0254; A61H 2201/0153; A61H 2201/0157; A61H 2201/1215; A61H 2201/1678; A61H 2201/5033

(57) ABSTRACT

Provided a vibrating spear, including a first body, a second body, and a turning assembly. The second body is provided with a sliding groove in a thickness direction thereof. The first body and the second body are rotationally connected. The turning assembly includes a motor and an eccentric part. One end of the eccentric part stretches into the sliding groove. A second connecting portion is provided with a first stopping surface and a second stopping surface that stop the eccentric part at an opening of the sliding groove, and an included angle between the first stopping surface and the second stopping surface is 25-35°, which limits the moving range of the eccentric part in the sliding groove. Thus, the turning amplitude of a hooking portion is controlled, and the problem that the vibrating spear excessively extrudes a clitoris or is insufficient in strength in a hooking process is avoided.

### BACKGROUND

### 1. Technical Field

The present application relates to the field of vibrating spears, and particularly relates to a vibrating spear.

### 2. Background Information

In an existing design of a vibrating spear, in order to make a vibrating effect of the vibrating spear more intensive after the vibrating spear is inserted into a clitoris, the vibrating spear is usually designed in sections. Moreover, different portions of the vibrating spear can rotate relative to each other. A motor drives the sections of the vibrating spear to swing to achieve a hooking effect in the clitoris. Therefore, a more intensive stimulation is generated in the clitoris through the vibration of the vibrating spear itself in addition to the hooking of the vibrating spear itself.

However, this vibrating spear has some problems in actual experience. On the one hand, the hooking amplitude of some vibrating spear is designed too small. When the vibrating spear is inserted into the clitoris and starts to hook, a user can hardly sense an apparent hooking effect, and the simulation to the clitoris is not enough, so that the experience is reduced. On the other hand, the rotating amplitude of some other vibrating spears is designed too large, which will result in pain of the clitoris as a result of excessive hooking of the vibrating spear in a using process, and is also harmful to improving the using experience.

Therefore, it is crucial to design a vibrating spear that is relatively moderate in hooking amplitude, and cannot only guarantee an enough stimulation intensity and effect on the clitoris, but also prevent the vibrating spear from excessively hooking to make the clitoris painful to improve the user experience.

### BRIEF SUMMARY

In view of this, it is necessary to provide a vibrating spear to solve the above problems.

An embodiment of the present application provides a vibrating spear, including:
a first body, including a bearing portion and a first connecting portion protruding from the bearing portion;
a second body, including a second connecting portion and a hooking portion arranged on the second connecting portion, where the second connecting portion is rotationally connected to the first connecting portion, and the second connecting portion is provided with a sliding groove in a thickness direction thereof; and
a turning assembly, including a motor and an eccentric part, where the motor is arranged in the bearing portion, one end of the eccentric part is arranged on an output shaft of the motor, and the other end thereof stretches into the sliding groove;
the eccentric part includes an eccentric shaft, and the eccentric shaft extends into the sliding groove;
when the eccentric shaft moves, the eccentric shaft pries the second body to rotate to an axis side of the eccentric shaft to be attached to a first stopping surface or a second stopping surface; and
where the second connecting portion is provided with the first stopping surface and the second stopping surface that stop the eccentric part at an opening of the sliding groove, and an included angle between the first stopping surface and the second stopping surface is 25-35°.

The present application provides a vibrating spear, including a first body, a second body, and a turning assembly. The second body is provided with a sliding groove in a thickness direction thereof. The first body and the second body are rotationally connected. The turning assembly includes a motor and an eccentric part. One end of the eccentric part stretches into the sliding groove. A second connecting portion is provided with a first stopping surface and a second stopping surface that stop the eccentric part at an opening of the sliding groove, and an included angle between the first stopping surface and the second stopping surface is 25-35°, which limits the moving range of the eccentric part in the sliding groove. Thus, the turning amplitude of a hooking portion is controlled, so that the problem that the vibrating spear excessively extrudes a clitoris or is insufficient in strength in a hooking process is avoided.

### BRIEF DESCRIPTION OF THE DRAWINGS

FIG. 1 is a three-dimensional structural diagram of a vibrating spear;

FIG. 2 is a three-dimensional structural diagram of the vibrating spear;

FIG. 3 is a structural exploded view of the vibrating spear;

FIG. 4 is a three-dimensional structural diagram of the vibrating spear with a hidden protective sleeve;

FIG. 5 is a three-dimensional structural diagram of a second body;

FIG. 6 is a three-dimensional structural diagram of the second body rotated to be stopped by a second stopping surface;

FIG. 7 is a structural exploded view of the second body rotated to be stopped by the second stopping surface;

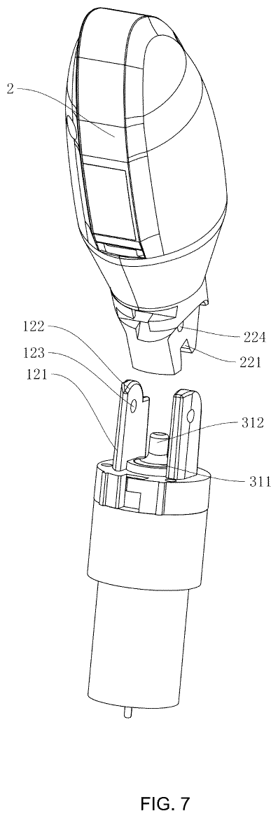

FIG. 8 is a schematic structural diagram of the second body rotated to be stopped by the second stopping surface;

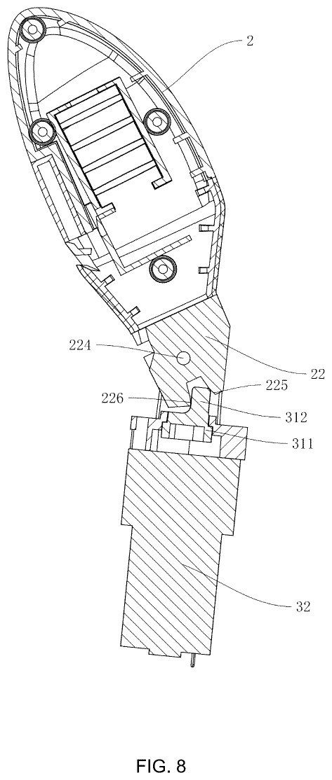

FIG. 9 is a three-dimensional structural diagram of the second body rotated to be stopped by a first stopping surface;

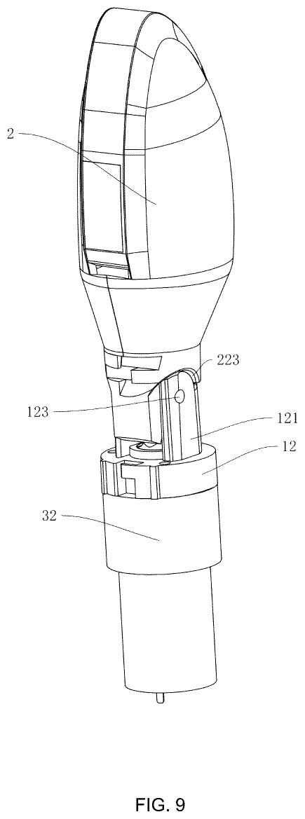

FIG. 10 is a structural exploded view of the second body rotated to be stopped by the first stopping surface; and

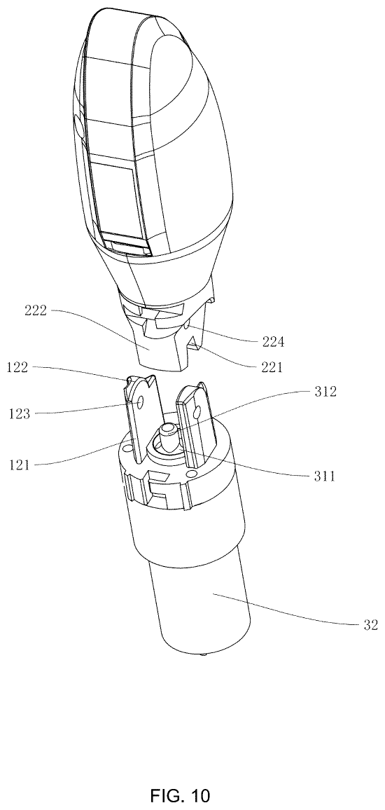

FIG. 11 is a schematic structural diagram of the second body rotated to be stopped by the first stopping surface.

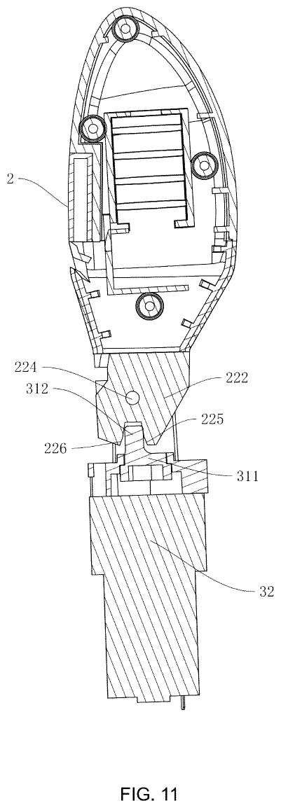

### DESCRIPTION OF SYMBOLS OF MAIN COMPONENTS

100, vibrating spear; 1, first body; 11, bearing portion; 12, first connecting portion; 121, sheet body; 122, circular truncated cone; 123, first rotating hole; 2, second body; 21, hooking portion; 22, second connecting portion; 221, sliding groove; 2211, third surface; 222, rotating member; 223, circular groove; 224, second rotating hole; 225, first stopping surface; 226, second stopping surface; 3, turning assembly; 31, eccentric part; 311, eccentric wheel; 312, eccentric wheel; 32, motor; 4, rotating shaft; 5, variable-speed knob; 51, anti-skid line; 6, protective sleeve.

### DETAILED DESCRIPTION OF THE DRAWINGS AND THE PRESENTLY PREFERRED EMBODIMENTS

A description will be made on the technical solution in the embodiment of the present application below in combination with drawings in the embodiment of the present application. It is apparent that the described embodiments are merely a part of embodiments of the present application and are not all the embodiments.

It should be noted that when one assembly is regarded as being connected with another assembly, the assembly can be directly connected to another assembly or an assembly arranged in the center may exist as well. When one assembly is regarded as being arranged on another assembly, the assembly may be directly arranged on another assembly or an assembly arranged in the center may exist as well. The terms “top”, “bottom”, “upper”, “lower”, “left”, “right”, “front”, “back”, and similar expressions used herein are merely for description purposes.

An embodiment of the present application provides a vibrating spear, including:
a first body, including a bearing portion and a first connecting portion protruding from the bearing portion;
a second body, including a second connecting portion and a hooking portion arranged on the second connecting portion, where the second connecting portion is rotationally connected to the first connecting portion, and the second connecting portion is provided with a sliding groove in a thickness direction thereof; and
a turning assembly, including a motor and an eccentric part, where the motor is arranged in the bearing portion, one end of the eccentric part is arranged on an output shaft of the motor, and the other end thereof stretches into the sliding groove;
where the second connecting portion is provided with the first stopping surface and the second stopping surface that stop the eccentric part at an opening of the sliding groove, and an included angle between the first stopping surface and the second stopping surface is 25-35°;
the eccentric part includes an eccentric shaft, and the eccentric shaft extends into the sliding groove; and
when the eccentric shaft moves, the eccentric shaft pries the second body to rotate to an axis side of the eccentric shaft around the rotating shaft to be attached to a first stopping surface or a second stopping surface. The present application provides a vibrating spear, including a first body, a second body, and a turning assembly. The second body is provided with a sliding groove in a thickness direction thereof. The first body and the second body are rotationally connected. The turning assembly includes a motor and an eccentric part. One end of the eccentric part stretches into the sliding groove. A second connecting portion is provided with a first stopping surface and a second stopping surface that stop the eccentric part at an opening of the sliding groove, and an included angle between the first stopping surface and the second stopping surface is 25-35°, which limits the moving range of the eccentric part in the sliding groove. Thus, the turning amplitude of a hooking portion is controlled, so that the problem that the vibrating spear excessively extrudes a clitoris or is insufficient in strength in a hooking process is avoided.

Embodiments of the present application will be described in detail below in combination with drawings. In the absence of conflict, the embodiments and features in the embodiments can be combined with one another.

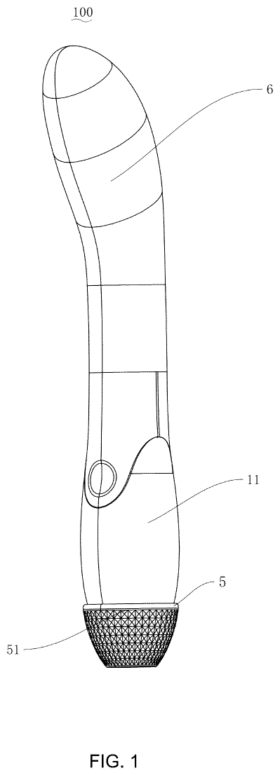

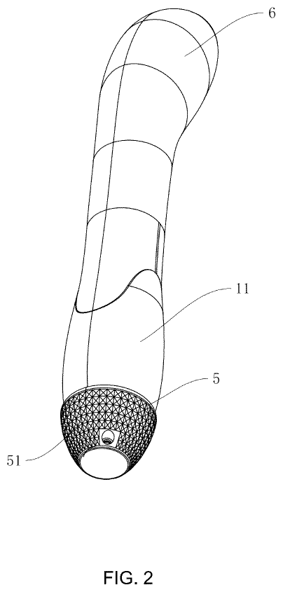

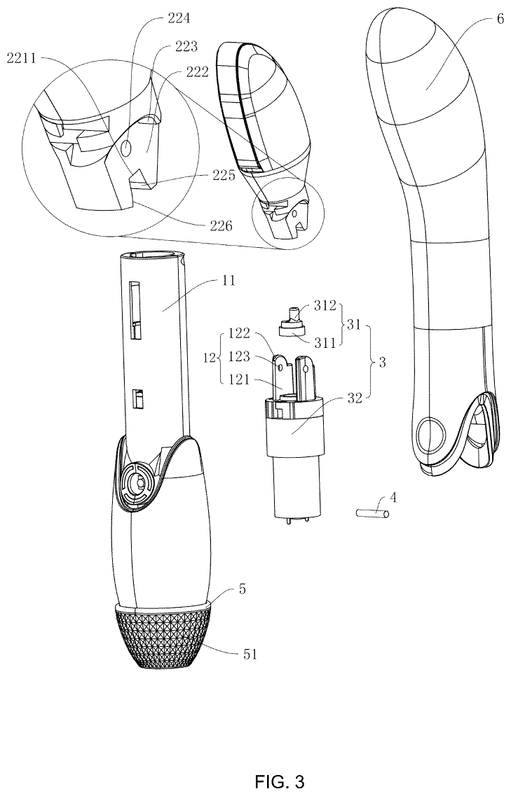

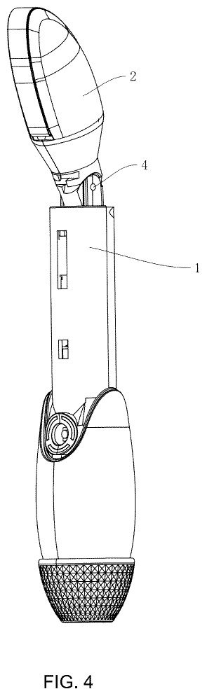

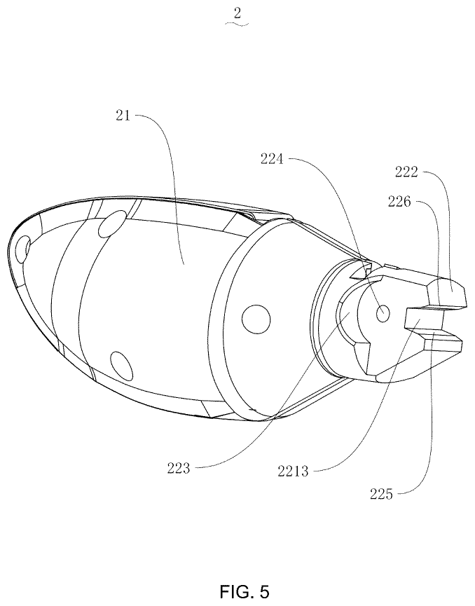

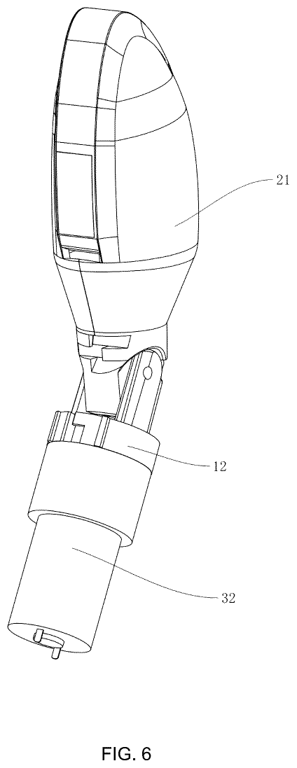

Referring to FIGS. 1-6, an embodiment of the present application provides a vibrating spear 100, including:
a first body 1, including a bearing portion 11 and a first connecting portion 12 protruding from the bearing portion 11;
a second body 2, including a second connecting portion 22 and a hooking portion 21 arranged on the second connecting portion 22, where the second connecting portion 22 is rotationally connected to the first connecting portion 12, and the second connecting portion 22 is provided with a sliding groove 221 in a thickness direction thereof; and
a turning assembly 3, including a motor 32 and an eccentric part 31, where the motor 32 is arranged in the bearing portion 11, one end of the eccentric part 31 is arranged on an output shaft of the motor 32, and the other end thereof stretches into the sliding groove 221; and
where the second connecting portion 22 is provided with the first stopping surface 225 and the second stopping surface 226 that stop the eccentric part 31 at an opening of the sliding groove 221, and an included angle between the first stopping surface 225 and the second stopping surface 226 is 25-35°.

Specifically, the bearing portion 11, as a main body structure of the vibrating spear 100, is used to support and fix other assemblies such as the motor 32 and the eccentric part 31. The first connecting portion 12 is used to be connected to the second body 2 to realize a rotating function of the hooking portion 21, thereby providing a stable supporting and connecting basis. The second body 2 includes the second connecting portion 22 and the hooking portion 21 arranged on the second connecting portion 22, where the second connecting portion 22 is rotationally connected to the first connecting portion 12, and the second connecting portion 22 is provided with a sliding groove 221 in a thickness direction thereof. The second connecting portion 22 is connected to the first connecting portion 12 to allow the hooking portion 21 to rotate around the first connecting portion 12. The hooking portion 21 is in direct contact with a user to provide a stimulation effect. The sliding groove 221 provides space for movement of the eccentric part 31, so as to realize the turning function of the hooking portion 21. The turning assembly 3 includes the motor 32 and the eccentric part 31, where the motor 32 is arranged in the bearing portion 11, one end of the eccentric part 31 is arranged on an output shaft of the motor 32, and the other end thereof stretches into the sliding groove 221. The motor 32 provides a power source for the vibrating spear 100 to drive the eccentric part 31 to rotate. The eccentric part 31 driven by the motor 32 moves in the sliding groove 221, so as to push the second portion 22 (and the hooking portion 21) to turn. By adjusting the rotating speed of the motor 32 and the shape of the eccentric part 31, the stimulation intensity and the turning amplitude to the clitoris can be flexibly controlled. The second connecting portion 22 is provided with the first stopping surface 225 and the second stopping surface 226 that stop the eccentric part 31 at an opening of the sliding groove 221, and an included angle between the first stopping surface 225 and the second stopping surface 226 is 25-35°. The stopping surfaces limit the moving range of the eccentric part 31 in the sliding groove 221 to control the turning amplitude of the hooking portion 21, so as to prevent damage due to excessive turning. By designing the included angle, the stimulation intensity is more uniform, so that the comfort level of the user is improved.

A specific actuating process is as follows: the user starts the vibrating spear 100, the motor 32 starts to work, then the output shaft of the motor 32 drives the eccentric part 31 to rotate, the eccentric part 31 moves in the sliding groove 221 to push the second connecting portion 22 (and the hooking portion 21) to turn, and when the eccentric part 31 moves to the first stopping surface 225 or the second stopping surface 226, in this case, the hooking portion 21 reaches the maximum turning angel, the eccentric part pries the hooking portion to turn in a reciprocating manner in an appropriate amplitude range due to limitation of the sliding groove in the rotating process, so as to achieve a massage effect. The length D of the hooking portion 21 of the existing vibrating spear 100 is usually 50-60 mm, and the hooking portion 21 in the present application is mainly suitable for this interval.

Further, in order to prove the optimum swinging amplitude of the hooking portion 21 during massaging, the solution designs a set of experiments. The experimental solution is as follows: an experimental apparatus is a prototype of the vibrating spear 100 (the included angle between the first stopping surface 225 and the second stopping surface 226 can be adjusted), an intensity sensor (for measuring the stimulation intensity), and a clitoral erection detection instrument (for detecting the erection degree of the clitoris hooked, the erection degree of the clitoris, high and low pleasant sensations). Because the length D of the hooking portion 21 of the existing vibrating spear 100 is usually 50-60 mm, the length D of the hooking portion 21 of the prototype of the vibrating spear 100 is set as 55 mm. Experimental subjects are 30 healthy volunteers aged 20-50 without apparent sexually diseases. The included angle between the first stopping surface 225 and the second stopping surface 226 is set as five representative angles: 20°, 25°, 30°, 35°, and 40°. At each angle, three different stimulation points of the hooking portion 21 located at a starting position (i.e., contact with the first stopping surface 225), a middle position (i.e., a middle point position of the included angle), and a terminating position (i.e., contact with the second stopping surface 226) are respectively set. Each experimental subject is massaged at each angle and each stimulation point, 5 minutes for massaging each time. After massaging each time is finished, the hooking intensity is measured by using the intensity sensor. The erection degree of the clitoris hooked is detected by using the clitoral erection detection instrument. A stimulation intensity mean value at each angle and each stimulation point is recorded as well as the erection degree mean value of the clitoris at each angle and each stimulation point.

Massage force mean value table

| Included | | Stimulation intensity |
|---|---|---|
| angle (°) | Stimulation point | mean value (N) |
| 20 | Starting position | 48 |
| | Middle position | 53 |
| | Terminating position | 50 |
| 25 | Starting position | 50 |
| | Middle position | 55 |
| | Terminating position | 52 |
| 30 | Starting position | 52 |
| | Middle position | 58 |
| | Terminating position | 54 |
| 35 | Starting position | 51 |
| | Middle position | 56 |
| | Terminating position | 53 |
| 40 | Starting position | 49 |
| | Middle position | 54 |
| | Terminating position | 51 |

Muscle relax degree mean value table (%)

| Included | | Erection degree |
|---|---|---|
| angle (°) | Stimulation point | of clitoris (%) |
| 20 | Starting position | 58 |
| | Middle position | 63 |
| | Terminating position | 60 |
| 25 | Starting position | 60 |
| | Middle position | 65 |
| | Terminating position | 62 |
| 30 | Starting position | 62 |
| | Middle position | 70 |
| | Terminating position | 64 |
| 35 | Starting position | 61 |
| | Middle position | 66 |
| | Terminating position | 63 |
| 40 | Starting position | 59 |
| | Middle position | 64 |

According the above experimental data, at the middle position at the included angle of 30°, the stimulation intensity is moderate (58N), the erection degree of the clitoris (70%) is increased from 20° to 40° with the angle. The stimulation intensity and the erection degree of the clitoris are in a trend of increasing first and then decreasing, and both reach the optimal values at the middle position at the included angle of 30°. These data indicate that when the included angle between the first stopping surface 225 and the second stopping surface 226 is 25-35° (particularly 30°), the vibrating spear has the optimal stimulation effect on the clitoris.

In a specific example, the first connecting portion 12 includes two sheet bodies 121, where the two sheet bodies 121 are located at one end of the bearing portion 11 close to the second body 2 and symmetrically arranged on both sides of the bearing portion 11.

The second connecting portion 22 includes a rotating member 222 located between the two sheet bodies 121.

The vibrating spear 100 further includes a rotating shaft 4, the rotating shaft 4 penetrating through the two sheet bodies 121 and the rotating member 222, and the second connecting portion 22 being rotationally connected to the first rotating portion 12 through the rotating shaft 4.

Specifically, the two sheet bodies 121, as a main component of the first connecting portion 12, provide a stable supporting structure for rotation of the second connecting portion 22. They are located at one end of the bearing portion 11 close to the second body 2 to determine the position of the rotational connection. The two sheet bodies 121 are symmetrically arranged on both sides of the bearing portion 11, which ensures the balance of the rotational connection, thereby contributing to reducing vibration and noise generated in the rotating process. The rotating member 222 is a core portion of the second connecting portion 22, which is located between the two sheet bodies 121 and is rotationally connected to the first connecting portion 12 through the rotating shaft 4. This allows the second body 2 (including the hooking portion 21) to rotate repeatedly relative to the first body 1. The rotating shaft 4 serves as a rotating shaft for rotational connection between the first connecting portion 12 and the second connecting portion 22. The rotating shaft penetrates through the two sheet bodes 121 and the rotating member 222. When the user starts the vibrating spear 100, the motor 32 starts to work to drive the eccentric part 31 (for example, the eccentric wheel 311) to rotate. One end of the eccentric part 31 is connected to the output end of the motor 32 and the other end thereof stretches into the sliding groove 221 of the second connecting portion 22. With the rotation of the eccentric part 31, the eccentric shaft 312 thereof moves in the sliding groove 221 to pry the second body 2 (including the rotating member 222 and the hooking portion 21) to rotate around the rotating shaft 4. Since the first stopping surface 225 and the second stopping surface 226 are arranged at the opening of the sliding groove 221, the moving direction of the eccentric shaft 312 will be changed under the action of these stopping surfaces when it moves, so that the hooking portion 21 rotates in a reciprocating manner.

In a specific example, a circular truncated cone 122 is arranged at one end of each of the sheet bodies 121 away from the bearing portion 11, the rotating member 222 is provided with a circular groove 223 corresponding to the circular truncated cone 122, and when the first connecting portion 12 and the second connecting portion 22 are rotationally connected, centers of circle of the circular truncated cone 122 and the circular groove 223 both are located on an axis of the rotating shaft 4.

Specifically, the design of the circular truncated cone 122 aims to realize a precise fit with the circular groove 223 on the rotating member 222. The circular truncated cone 122 usually has a relatively smooth curved surface and a precise size to ensure tight fit and smooth rotation with the circular groove 223, so as to enhance the connecting stability between the first connecting portion 12 and the second connecting portion 22, so as to reduce a gap and swing which may be generated in the rotating process of the second body. The circular groove 223 is a key structure on the rotating member 222 to accommodate the circular truncated cone 122 on each of the sheet bodies 121. The circular groove 223 matches with the circular truncated cone 122 in size and shape to ensure a tight fit therebetween. The circular groove 223 is designed, so that the first connecting portion 12 and the second connecting portion 22 are more stable when being rotationally connected, and therefore, friction and wear generated by mismatch are reduced. When the first connecting portion 12 and the second connecting portion 22 are rotationally connected through the rotating shaft 4, the circular truncated cone 122 is embedded into the circular groove 223, and the rotating shaft 4 penetrates through medial axes of the circular truncated cone 122 and the circular groove 223. This design ensures the stability and smoothness of the rotational connection. Through the tight fit between the circular truncated cone 122 and the circular groove 223 and penetration by the rotating shaft 4, the first connecting portion 12 and the second connecting portion 22 can rotate precisely.

In a specific example, the eccentric part 31 includes:
an eccentric wheel 311, the eccentric wheel 311 being in transmission connection to the motor 32; and the motor 32 driving the eccentric wheel 311 to rotate around a rotating shaft of the eccentric wheel 311, where
an eccentric shaft 312 is arranged on one end of the eccentric wheel 311 away from the motor 32, and the eccentric wheel 312 extends into the sliding groove 221;
when the eccentric wheel 312 moves, the eccentric wheel 312 pries the second body 2 to rotate around the rotating shaft 4 to an axis side of the eccentric wheel 312 to be attached to the first stopping surface 225 or the second stopping surface 226.

Specifically, the eccentric part 31 is a name of a whole assembly, including a plurality of portions to jointly realize a special function. The eccentric wheel 311 is one of the major portions of the eccentric part 31, which is usually an asymmetrical shaft, i.e., the eccentric shaft 312. The eccentric wheel 311 is connected to the motor 32 through a certain transmission mechanism (for example, a gear, a belt, and the like), so that the motor 32 can drive the eccentric wheel to rotate. The motor 32 is a component that provides power, which generates power by rotation and transfers the power to the eccentric wheel 311 through the transmission mechanism. The eccentric wheel 311, driven by the motor 32, will rotate around the rotating shaft thereof (i.e., the symmetrical central shaft of the eccentric wheel 311, but not necessarily the eccentric shaft 312). The eccentric shaft 312 is a key portion on the eccentric wheel 311, which is located at one end of the eccentric wheel 311 away from the motor 32 and is eccentric relative to the rotating shaft of the eccentric wheel 311. Part of the eccentric shaft 312 will stretch into a certain sliding groove 221. When the eccentric wheel 311 driven by the motor 32 rotates, it will pry the second body 2 to rotate around the rotating shaft 4 thereof, and the eccentric shaft 312 will move in the sliding groove 221. In the rotating process, the second body 2 will be certainly limited (for example, by the stopping surfaces). When the second rotates to a certain special position, the axis side of the eccentric shaft 312 will be attached to these stopping surfaces, which limits further rotation of the second body 2.

In a specific example, the sliding groove 221 includes a third surface 2211 located between the first stopping surface 225 and the second stopping surface 226, the third surface 2211 and the eccentric shaft 312 being arranged in a spaced manner.

Specifically, the first stopping surface 225 and the second stopping surface 226 are respectively located at both ends of the sliding groove 221, and the included angle therebetween (usually 25-35°) provides limitation and guidance to movement of the eccentric shaft 312. The third surface 2211 is located between the first stopping surface 225 and the second stopping surface 226 to form a relatively flat surface or a surface with a special curvature. This surface is not in direct contact with the eccentric shaft 312 but is spaced from the eccentric shaft. The existence of the gap provides certain movement space for the eccentric shaft 312, which prevents the eccentric shaft 312 from being clamped in the sliding groove.

In a specific example, a variable-speed knob 5 is arranged at one end of the first body 1 away from the second body 2 for adjusting a rotating speed of the motor 32.

Specifically, the variable-speed knob 5 is located at a distal end of the first body 1, i.e., one end away from the second body 2 (including the hooking portion 21), for convenience of user operation. The major function of the variable-speed knob 5 is to adjust the rotating speed of the motor 32, so as to control the massage intensity and frequency of the vibrating spear 100. The variable-speed knob 5 is usually connected to the motor 32 mechanically or electronically. In the mechanical connection, the button may directly act on a speed regulating mechanism of the motor 32, for example, change an input voltage or current of a power supply of the motor 32 or adjust the rotating speed of the motor 32 through a transmission device such as a gear and a belt. In the electronic connection, the button may be a potentiometer or an encoder, and a signal outputted thereby is converted into an instruction capable of being recognized by a controller of the motor 32, so that the rotating speed of the motor 32 is adjusted. When the user rotates the variable-speed knob 5, this action will trigger the above connecting mechanism, resulting in a change in the rotating speed of the motor 32.

In a specific example, anti-skid lines 51 are provided on the variable-speed knob 5.

Specifically, in the design of the vibrating spear 100, in order to ensure that the user can stably operate the variable-speed knob 5, particularly in the case that the hand is wetted or sweats, a designer adds the design element anti-skid lines 51 on the surface of a rotary knob. The anti-skid lines 51 usually include a series of tiny bumps or grooves. These bumps or grooves can be linear, wavy, spiral, and the like. Different shapes can provide frictional forces and hand feelings of different degrees to fit the using habits of different users. The anti-skid lines 51 are usually processed together with a main body material of the rotary knob to ensure a firm connection therebetween. A common material includes a plastic, rubber or a metal, and the like. These materials are selected depending on the integral design style of the vibrating spear 100, cost budgeting, and the using environment of the user.

In a specific example, the vibrating spear 100 further includes a protective sleeve 6, the protective sleeve 6 being sleeved on the first body 1, the second body 2 being located in the protective sleeve 6, and the variable-speed knob 5 being located outside the protective sleeve 6.

Specifically, the vibrating spear 100 further includes the protective sleeve 6, indicating that, besides main components such as the first body 1, the second body 2, and the variable-speed knob 5, the vibrating spear 100 is additionally equipped with a protective sleeve 6. The protective sleeve 6 is sleeved on the first body 1, which indicates that the protective sleeve 6 is sleeved outside the first body 1. The protective sleeve 6 usually has enough elasticity and strength and can be tightly attached to the first body 1, so as to prevent an external object from directly impacting or damaging the first body 1. The second body 2 is located in the protective sleeve 6, which indicates that the second body 2 is included in the protective sleeve 6. Since the protective sleeve 6 is sleeved on the first body 1 and the second body 2 is connected or adjacent to the first body 1, the second body 2 is also naturally covered by the protective sleeve 6. This design contributes to preventing the second body 2 from being interfered with or damaged by an external environment. The variable-speed knob 5 is located outside the protective sleeve 6, which indicates that the variable-speed knob 5 is exposed outside the protective sleeve 6. The variable-speed knob 5 is a component for the user to operate. therefore, it needs to be exposed outside the protective sleeve 6 for the user to operate freely. If the variable-speed knob 5 is covered by the protective sleeve 6, it cannot exert its required effect.

In a specific example, the protective sleeve 6 is made of rubber.

Specifically, the protective sleeve 6 is an important component of the vibrating spear 100 and is usually used to wrap or cover other components of the vibrating spear 100, so as to provide extra protection and safety. The protective sleeve 6 is made of rubber. Rubber with good elasticity can be suitable for components with different shapes and sizes. Rubber has relatively high wear resistance, which can resist friction and wear of an external object. The surface of rubber usually has a certain roughness, so that the rubber can increase the frictional force with the hand or other objects to prevent the vibrating spear 100 from falling off or sliding in the using process.

In a specific example, a first rotating hole 123 is formed in each of the two circular truncated cones 122, a second rotating hole 224 is formed in the second connecting portion 22, both ends of the second rotating hole 224 are aligned with the two first rotating holes 123, respectively, and the rotating shaft 4 penetrates through the two first rotating holes 123 and the second rotating hole 224.

Specifically, the first rotating hole 123 is formed in each of the two circular truncated cones 122, which indicates that there are two structures 122 in a circular truncated cone shape. Each of the two circular truncated cones 122 is provided with one or more first rotating holes 123. These first rotating holes 123 are usually used to allow a rotating movement in a certain form, for example, a movement of a shaft or a rod. The second rotating hole 224 is formed in the second connecting portion 22, which indicates that besides the two circular truncated cones 122, there is still a structure called the second connecting portion 22. One or more second rotating holes 224 are also formed in the second connecting portion 22. These second rotating holes 224 may be similar to the first rotating holes 123 in terms of function, allowing the rotating movement. Both ends of each of the second rotating holes 224 are respectively connected to the two first rotating holes 123, which indicates that the second rotating holes 224 are not isolated but are connected to the first rotating holes 123 in the two circular truncated cones 122. This connectivity allows one shaft or rod to penetrate through the three holes at the same time, so as to realize relative rotation between the two circular truncated cones 122 and the second connecting portion 22. The rotating shaft 4 penetrates through the first rotating holes 123 in the two circular truncated cones 122 and the second rotating holes 224 in the second connecting portion 22. The two circular truncated cones 122 rotate around the rotating shaft 4 relative to the second connecting portion 22.

The above is merely the implementation of the present disclosure. It should be noted that those of ordinary skill in the art may further make improvements without departing from the creative concept of the present application, and these improvements all fall within the protection scope of the present application.

1. A vibrating spear, comprising:
a first body, comprising a bearing portion and a first connecting portion protruding from the bearing portion;
a second body, comprising a second connecting portion and a hooking portion arranged on the second connecting portion, wherein the second connecting portion is rotationally connected to the first connecting portion, and the second connecting portion is provided with a sliding groove in a thickness direction thereof; and
a turning assembly, comprising a motor and an eccentric part, wherein the motor is arranged in the bearing portion, one end of the eccentric part is arranged on an output shaft of the motor, and the other end thereof stretches into the sliding groove;
the eccentric part comprises an eccentric shaft, and the eccentric shaft extends into the sliding groove;
when the eccentric shaft moves, the eccentric shaft pries the second body to rotate to an axis side of the eccentric shaft to be attached to a first stopping surface or a second stopping surface; and
wherein the second connecting portion is provided with the first stopping surface and the second stopping surface that stop the eccentric part at an opening of the sliding groove, and an included angle between the first stopping surface and the second stopping surface is 25-35°.

2. The vibrating spear according to claim 1, wherein the first connecting portion comprises two sheet bodies, the two sheet bodies being located at one end of the bearing portion close to the second body and symmetrically arranged;
the second connecting portion comprises a rotating member located between the two sheet bodies; and
the vibrating spear further comprises a rotating shaft, the rotating shaft penetrating through the two sheet bodies and the rotating member, and the second connecting portion being rotationally connected to the first rotating portion through the rotating shaft.

3. The vibrating spear according to claim 2, wherein a circular truncated cone is arranged at one end of each of the sheet bodies away from the bearing portion, the rotating member is provided with a circular groove corresponding to the circular truncated cone, when the first connecting portion and the second connecting portion are rotationally connected, the circular truncated cone is located in the circular groove, and centers of circle of the circular truncated cone and the circular groove both are located on an axis of the rotating shaft.

4. The vibrating spear according to claim 1, wherein the eccentric part comprises:
an eccentric wheel, the eccentric wheel being in transmission connection to the motor, and the motor driving the eccentric wheel to rotate around a rotating shaft of the eccentric wheel.

5. The vibrating spear according to claim 1, wherein the sliding groove comprises a third surface located between the first stopping surface and the second stopping surface, the third surface and the eccentric shaft being arranged in a spaced manner.

6. The vibrating spear according to claim 1, wherein a variable-speed knob is arranged at one end of the first body away from the second body for adjusting a rotating speed of the motor.

7. The vibrating spear according to claim 6, wherein anti-skid lines are provided on the variable-speed knob.

8. The vibrating spear according to claim 6, further comprising a protective sleeve, the protective sleeve being sleeved on the first body, the second body being located in the protective sleeve, and the variable-speed knob being located outside the protective sleeve.

9. The vibrating spear according to claim 8, wherein the protective sleeve is made of rubber.

10. The vibrating spear according to claim 3, wherein a first rotating hole is formed in each of the two circular truncated cones, a second rotating hole is formed in the second connecting portion, both ends of the second rotating hole are aligned with the two first rotating holes, respectively, and the rotating shaft penetrates through the two first rotating holes and the second rotating hole.
